(19) United States
(12) Patent Application Publication
(10) Pub. No.: US 2017/0010347 A1
(43) Pub. Date: Jan. 12, 2017

(54) TEST BENCH FOR TESTING A DISTANCE RADAR INSTRUMENT FOR DETERMINING DISTANCE AND SPEED OF OBSTACLES

(71) Applicant: dSPACE digital signal processing and control engineering GmbH, Paderborn (DE)

(72) Inventors: Frank Schütte, Warburg (DE); Albrecht Lohöfener, Paderborn (DE); Carsten Grascher, Paderborn (DE); Michael Rozmann, Eichenau (DE)

(21) Appl. No.: 15/204,325

(22) Filed: Jul. 7, 2016

(30) Foreign Application Priority Data
Jul. 8, 2015 (DE) 102015111014.8
Jul. 6, 2016 (EP) 16178215.6

(51) Int. Cl. G01S 7/40

(52) U.S. Cl. CPC G01S 7/4052; G01S 2007/4082

(57) ABSTRACT

A test bench for testing a distance radar instrument for determining distance and speed of obstacles, comprising a radar emulation device comprising at least one radar antenna and a computer unit with a model of the surroundings, wherein the model of the surroundings comprises data (x, v) of at least one obstacle with a relative position and speed from the distance radar instrument, wherein the radar emulation device emits a suitable reflection radar signal on the basis of the relative position and speed predetermined by the model of the surroundings at least partly in the direction of the distance radar instrument after receiving a scanning radar signal from the distance radar instrument such that the distance radar instrument detects an obstacle with a predetermined relative position and speed, wherein the radar emulation device extends over an angular range in front of the distance radar instrument such that the obstacle with relative position and speed can be simulated in this angular range with mutually distinguishable angles and wherein the radar emulation device comprises a multiplicity of stationary radar antennas which are distributed over the angular range.

### CROSS REFERENCE TO RELATED APPLICATIONS

This application claims the benefit of German patent application no. DE102015111014.8, filed on Jul. 8, 2015; and European patent application no. EP16178215.6, filed on Jun. 6 2016. This application is related to the co-pending commonly assigned United States non-provisional application titled “TEST BENCH FOR TESTING A DISTANCE RADAR INSTRUMENT FOR DETERMINING DISTANCE AND SPEED OF OBSTACLES”, with application Ser. No. ______. The entire contents of all are hereby incorporated by reference in its entirety.

### BACKGROUND OF THE INVENTION

Typical distance radar instruments comprise one or more radar antennas, a logic unit for measuring and evaluating detected radar signals and interfaces to other control instruments of the vehicle. The radar instrument transmits suitable electromagnetic waves in the radiofrequency range—in this case as a scanning radio signal—into a specific direction of the surroundings thereof and waits for a reflected echo signal—the reflection radar signal. The generation of such radio waves is sufficiently well known; exemplary methods include frequency modulated continuous wave radar and pulse compression based methods. These systems are used to produce and receive a radar signal reflected at an obstacle, which allows conclusions to be drawn about the relative position and speed of the object and the receiver. This is typically done by evaluating the time-of-flight of the pulse and the frequency shift (Doppler effect). The scanning radar instrument scans its surroundings over angular steps and thus obtains spatially resolved information about position and speed of the surrounding obstacles within the scanned area. Distance radar instruments can be installed on a vehicle's exterior, e.g. in the radiator hood, or within the vehicle, e.g. in the upper part of the windshield.

Emulation devices exist to test distance radar instruments. Known emulation devices comprise a radar antenna that receives the scanning radar signal from a distance radar instrument under test. In response to the received signal, the emulation device generates a simulated reflection radar signal, based on a predetermined relative position and speed data. The simulated reflection radar signal is received by the radar instrument under test, which interprets the signal to identify a simulated obstacle using the predetermined relative position and speed data. Such an exemplary device is described, for example, in the product brochure of the ARTS9510 by Rohde&Schwarz (retrievable from https://www.rohde-schwarz.com/en/product/arts9510-productstartpage_63493-114114.html, retrieved 2015).

These radar emulation devices known from the prior art and test benches using such radar emulation devices are not suitable for representing situations of the surroundings in a realistic way.

### BRIEF SUMMARY OF THE INVENTION

It is an object of the present disclosure to describe the test benches that provide realistic situations of the surroundings. Test benches are often used to test individual components from motor vehicles and control devices of motor vehicles in the laboratory under real physical conditions. To this end, the data and measurement values, which the component to be tested requires, are calculated by means of a suitable model of the remaining vehicle and the surroundings thereof—the model of the surroundings in this case—and converted into real physical variables by methods known in the art.

The inventions of the present disclosure are based on the discovery that the detection of three-dimensional, extended objects is required when testing a distance radar instrument in complex test scenarios with a three-dimensional model of the surroundings in order to be able to make a realistic assessment of the functionality of the distance radar instrument to be tested.

The disclosed inventions relate to a test bench for testing a distance radar instrument for determining distance and speed of obstacles, comprising a radar emulation device comprising at least one radar antenna and a computer unit with a model of the surroundings, wherein the model of the surroundings comprises data of at least one obstacle with a relative position and speed from the distance radar instrument, wherein the radar emulation device emits a suitable reflection radar signal on the basis of the relative position and speed predetermined by the model of the surroundings at least partly in the direction of the distance radar instrument after receiving a scanning radar signal from the distance radar instrument such that the distance radar instrument detects an obstacle with a predetermined relative position and speed and that the radar emulation device comprises a multiplicity of stationary radar antennas which are distributed over the angular range.

In conjunction with the disclosed inventions, a model of the surroundings is understood to be a surroundings model, in which the vehicle model, which is connected to the component to be tested, moves and with which it interacts. By way of example, the model of the surroundings is a three-dimensional representation of a road network with a virtual test track, and moreover comprises additional movable road users (e.g., vehicles, pedestrians) and non-moving objects such as guardrails, other obstacles and the like. However, in the simplest form thereof, the model of the surroundings can comprise a single vehicle and define the relative speed and position thereof.

In the disclosed inventions, a distance radar instrument is understood to mean an electronic control instrument comprising at least one radar antenna for transmitting and receiving radar signals, for installation into a motor vehicle. By way of example, such distance radar instruments are used to obtain measurement data from the vehicle surroundings for an automatic emergency brake (AEB), for an adaptive cruise control (ACC) and for lane change support (LCS). These safety-relevant automatic controls require real-time information about the position and speed of approaching obstacles such as e.g. road users or stationary objects in the vehicle surroundings in order to be able to intervene into the vehicle guidance in good time and in order to avoid collisions.

In accordance with the subject matter of the invention, a test bench for testing a distance radar instrument for determining distance and speed of obstacles is proposed, comprising a radar emulation device comprising at least one radar antenna and a computer unit with a model of the surroundings, wherein the model of the surroundings comprises data of at least one obstacle with a relative position and speed from the distance radar instrument, wherein the radar emulation device emits a suitable reflection radar signal on the basis of the relative position and speed predetermined by the model of the surroundings at least partly in the direction of the distance radar instrument after receiving a scanning radar signal from the distance radar instrument such that the distance radar instrument detects an obstacle with a predetermined relative position and speed.

The test bench according to the disclosed system includes a radar emulation device that extends over an angular range in front of the distance radar instrument such that the obstacle with relative position and speed can be simulated in this angular range with mutually distinguishable angles, and in that the radar emulation device comprises a multiplicity of stationary radar antennas which are distributed over the angular range.

In one development, the test bench has such a design that the azimuthal portion of the position of the simulated obstacle is set by the azimuthal position of the radar antenna of the radar emulation device emitting the reflection radar signal and the vertical portion of the position of the simulated obstacle is set by the vertical position of the radar antenna of the radar emulation device emitting the reflection radar signal. Thus, if the object to be simulated moves, there is a change in the radar antenna which is responsible for emitting the reflection radar signal. Even though the respective receiving radar antenna can also emit the corresponding reflection radar signal, the position of the radar antenna responsible for receiving the scanning radar signal can be selected independently to a certain extent, provided it assists the distance radar instrument. This test bench arrangement is suitable for distance radar instruments which do not laterally deflect the distance radar signal. When receiving a reflection radar signal, these distance radar instruments detect an obstacle in the direction from which the reflection radar signal is received. All that needs to be ensured is that the scanning radar signal is detectable for the radar antenna responsible for receiving the scanning radar signal; the exact position of this radar antenna then is irrelevant.

In one development, the test bench has such a design that the azimuthal portion of the position of the simulated obstacle is set by the azimuthal position of the detecting radar antenna of the radar emulation device and the vertical portion of the position of the simulated obstacle is set by the vertical position of the detecting radar antenna of the radar emulation device. Thus, if the object to be simulated moves in the azimuthal direction, there is a change in the radar antenna responsible for receiving the scanning radar signal of the reflection radar signal. Even though this respective receiving radar antenna can also emit the corresponding reflection radar signal, the position of the radar antenna responsible for emitting the reflection radar signal can be selected independently to a certain extent, provided it assists the distance radar instrument. This test bench arrangement is suitable for distance radar instruments which laterally deflect the scanning radar signal and, in the subsequent reception of a reflection radar signal, detect an obstacle in the direction in which the scanning radar signal was emitted. All that needs to be ensured is that the distance radar instrument can receive the reflection radar signal; the exact position of the radar antenna which emits the reflection radar signal then is irrelevant.

In a further embodiment, the test bench is equipped with a number of radar antennas at a mutual angular spacing corresponding to a predetermined angular resolution. A high angular resolution also allows the simulation of complex situations predetermined by the surroundings model by way of the test bench. Thus, for example, the simulated obstacle can have a characteristic reflection pattern, on the basis of which the distance radar instrument distinguishes various road users, e.g. automobiles and pedestrians, from one another.

In one development, the test bench is designed in such a way that the radar antennas are arranged on a contour extending in a straight line. By way of example, a straight-line contour is a rail, on which the radar antennas are arranged next to one another. A further example is a planar surface, which is equipped with radar antennas in a two-dimensional distribution and which therefore cover a two-dimensional angular range.

In another embodiment, the test bench is designed in such a way that the radar antennas are arranged on a concave contour with an opening in the direction of the distance radar instrument. By way of example, provision can be made for this arrangement for the radar antenna to be arranged on a curved rail. A further example is the attachment of a multiplicity of radar antennas on the inner contour of a hollow ellipsoid, for example partial sphere, wherein the opening points in the direction of the distance radar instrument to be tested.

In one development, the test bench is designed in such a way that a first radar antenna receives the scanning signal and a second radar antenna subsequently transmits the reflection radar signal, wherein the second antenna does not necessarily have the same position as the first radar antenna.

Depending on the type of the employed distance radar instrument, the radar antennas are positioned on the test bench for receiving the scanning radar signal and transmitting the reflection radar signal. In the case of scanning radar instruments that do not use a lateral deflection of the scanning radar signal, the location of the radar antenna receiving the distance radar signal is not important. To a good approximation, the identified position of the reflecting obstacle will be the one corresponding to the angle of incidence of the received reflection radar signal. In other types of scanning radar instruments which use a deflection of the scanning radar signal, the radar antenna emitting the reflection radar signal need not necessarily be at the same position at which the scanning radar signal is received. The identified position of the reflecting obstacle will, to a good approximation, be the one corresponding to the angle of the emitted scanning radar signal.

In an alternative embodiment, the test bench is designed in such a way that the model of the surroundings comprises data about the material properties of the obstacle and the reflection radar signal emitted by the radar emulation device in the direction of the distance radar instrument is constituted in such a way that the radar emulation device detects the material properties of the simulated obstacle. This is based on the discovery that radar signals are reflected with different signal damping from materials with different material properties, e.g. metallic or wooden surfaces. In this alternative embodiment, this is used by virtue of known materials being associated with typical characteristic damping values and these being disclosed to the distance radar instrument. Then, the radar emulation device generates a suitable reflection radar signal with the characteristic damping fitting to the simulated material. The distance radar instrument then is able to deduce the material properties from the measured damping.

In a further variant of the test bench for testing a distance radar instrument for determining distance and speed of obstacles, the radar emulation device is connected to the distance radar instrument in a closed control loop in such a way that the obstacle can be simulated in real time; such a simulation design is also referred to as a hardware-in-the-loop simulation.

In an alternative embodiment of the test bench for testing a distance radar instrument for determining distance and speed of obstacles, the radar emulation device is designed in such a way that the scanning radar signal initially passes over at least one deflection mirror for mirroring radar waves prior to being detected by a radar antenna. Alternatively, or additionally, the reflection radar signal initially can pass over at least one deflection mirror for mirroring radar waves prior to being detected by the distance radar instrument. Here, an arrangement of a plurality of a stationary or movably attached mirrors is also conceivable, said mirrors being installed in such a way that the number of radar antennas in the radar emulation device can be reduced.

### BRIEF DESCRIPTION OF THE DRAWINGS

The invention is explained in more detail below with reference to the drawings. Here, equivalent parts are denoted by identical reference signs. The illustrated embodiments are highly schematic, i.e. the distances and the lateral and vertical extents are not true to scale and, provided nothing else is specified, they do not have any derivable geometric relations to one another either. In detail:

FIG. 1 is a schematic view of a first embodiment of a test bench according to the invention for testing a distance radar instrument for determining distance and speed of obstacles,

FIG. 2 is a schematic view of a test bench according to the invention in an embodiment comprising radar antennas at different levels in a lateral view,

FIG. 3 is a schematic view of a test bench according to the invention in an embodiment comprising an arrangement of stationary radar antennas,

FIG. 4 is a schematic view of a test bench according to the invention in an embodiment comprising an arrangement of stationary radar antennas and an exemplary illustration of the simulation of an overtaking maneuver,

FIG. 5 is a schematic illustration of a test bench according to the invention in an embodiment comprising an arrangement of stationary radar antennas on a planar surface, and

FIG. 6 is a schematic illustration of a test bench according to the invention in an embodiment comprising an arrangement of stationary radar antennas in a hollow ellipsoid.

### DETAILED DESCRIPTION OF THE INVENTION

The following descriptions of the various embodiments are exemplary and not intended to limit the scope of the claimed inventions.

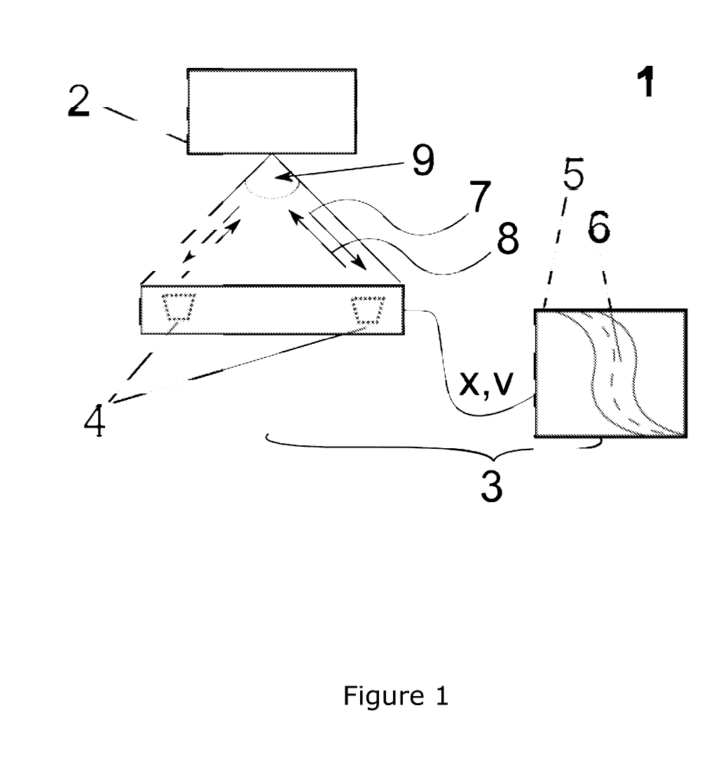

FIG. 1 shows the schematic illustration of a test bench 1 for testing a distance radar instrument 2 for determining distance and speed of obstacles. Shown is a radar emulation device 3, which comprises at least one radar antenna 4 and a computer unit 5 with a model of the surroundings 6. The model of the surroundings 6 is indicated by a stylized road, but it can contain movable road users such as vehicles and non-moving obstacles in addition to road surroundings. The model of the surroundings 6 provides data (x, v) for the relative position and speed of an obstacle in relation to the distance radar instrument 2. After receiving a scanning radar signal 7 emanating from the distance radar instrument 2, the radar emulation device 3 emits a suitable reflection radar signal 8 at least partly in the direction of the distance radar instrument 2 on the basis of the data (x, v). Said distance radar instrument 2 then detects an obstacle with the predetermined relative position and speed. Thus, the radar emulation device 3 extends over an angular range 9 in front of the distance radar instrument 2, which can also simulate a plurality of obstacles with relative position and speed in this angular range 9 with mutually distinguishable angles, or it is also possible to simulate an obstacle with lateral movement.

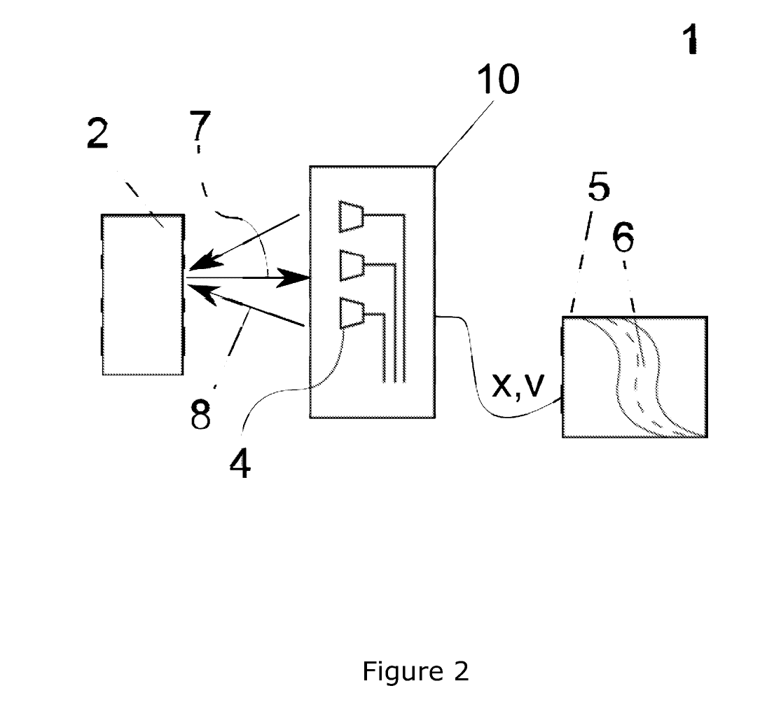

FIG. 2 depicts a lateral view of the test bench 1 for testing a distance radar instrument 2 for determining distance and speed of obstacles. In this embodiment, the radar antennas are situated on a positioning system 10, which is only indicated here by a box, wherein each one of the radar antennas 4 is guided at a different level in order to avoid the shadowing of one another.

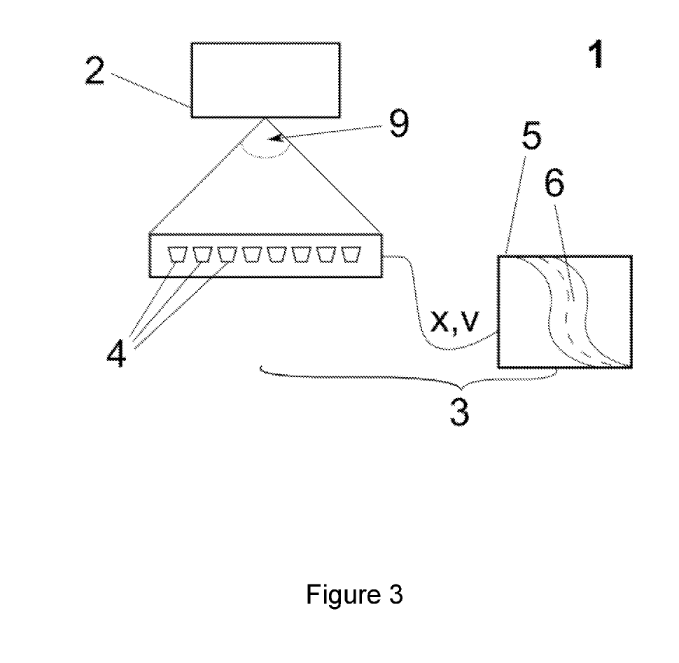

A further embodiment of the test bench 1 for testing a distance radar instrument 2 for determining distance and speed of obstacles is depicted in FIG. 3. In this embodiment, provision is made of arranging a plurality of stationary radar antennas 4. This arrangement covers the angular range 9 according to the invention. In this exemplary embodiment, provision is made for the obstacle to be simulated always to be represented by the stationary radar antennas 4 which are arranged in the angular portion in which the vehicle to be simulated is situated in respect of the distance radar instrument 2.

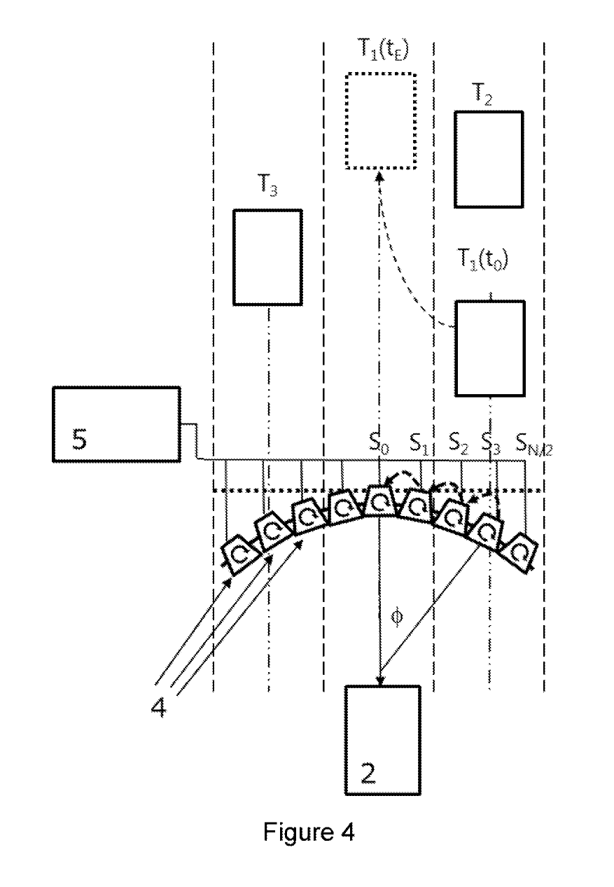

FIG. 4 shows an exemplary illustration of the test bench 1 for testing a distance radar instrument 2 for determining distance and speed of obstacles by illustrating an overtaking maneuver to be simulated with three involved vehicles T1, T2 and T3, which are all situated in front of the distance radar instrument 2 to be tested. The relative position and speed of the simulated vehicles is calculated by the radar emulation device 3. The results are indicated schematically above the arrangement of the radar antennas 4. In this case, the depicted embodiment according to the invention is an arrangement of stationary radar antennas 4 on a concave guide contour which is open toward the distance radar instrument 2. In this example, each one of the three vehicles T1, T2 and T3 is each represented by the radar antenna 4 situated at the azimuthal angle φ in which the vehicle to be simulated is currently situated. Thus, the vehicle T1(t₀) is initially represented by radar antenna S3 at the instant t₀; the responsibility for representing the vehicle is transferred to the antenna S2 and then to the antenna S1 during the overtaking maneuver and it is transferred to S0 after completion of the overtaking maneuver. Now, the vehicle is drawn with the dashed representation and denoted by T1(t_{E}). Here, the reflection radar signal to be generated transfers step-by-step from radar antenna to radar antenna (indicated by the dotted arrows).

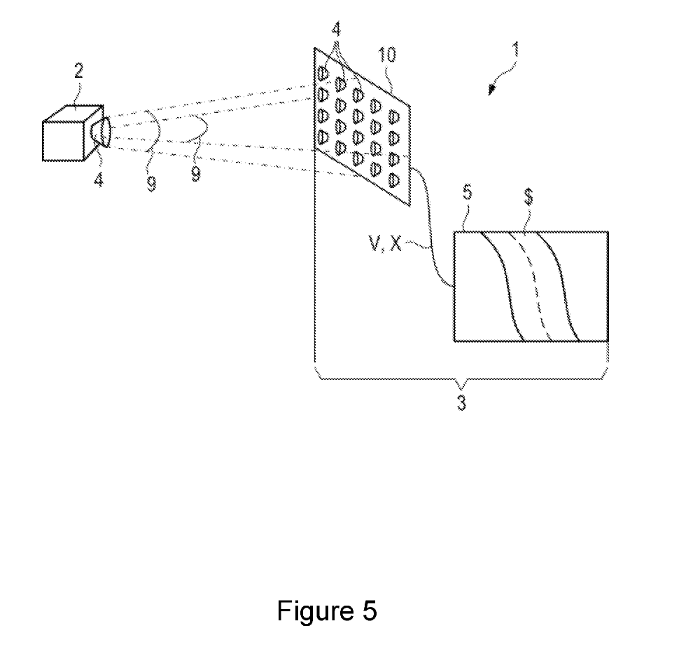

FIG. 5 shows a further embodiment of the test bench 1 for testing a distance radar instrument 2 for determining distance and speed of obstacles. Here, the test bench 1 comprises a positioning system 10 in the form of a planar surface. A multiplicity of radar antennas 4 are attached to the planar surface and enable a high spatial resolution of the scene simulated for the distance radar instrument 2 to be tested, said scene being predetermined by the surroundings model 6 on the computer unit and being represented by the radar antennas 4. The planar surface equipped with the radar antennas 4 is aligned onto the distance radar instrument 2 to be tested and enables a representation of surrounding simulated obstacles with extent in the azimuthal and vertical direction (angle 9).

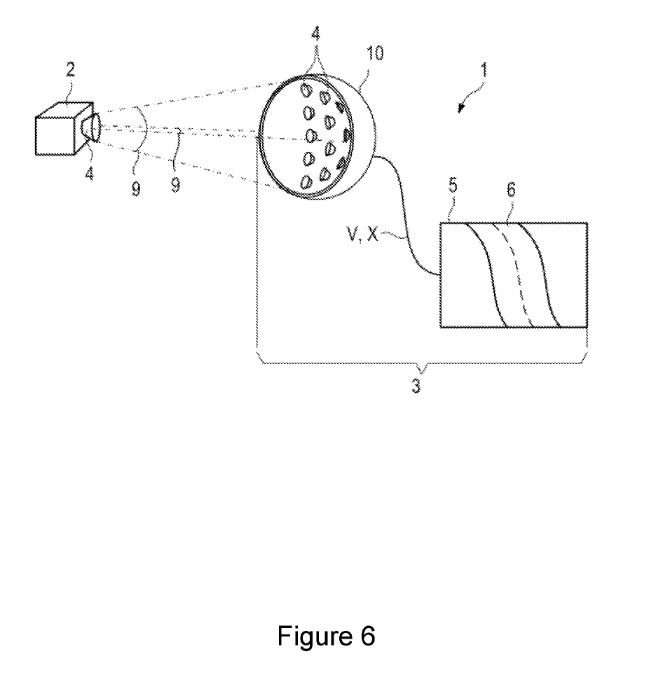

FIG. 6 shows a further embodiment of the test bench 1 for testing a distance radar instrument 2 for determining distance and speed of obstacles. Here, the test bench 1 comprises a positioning system 10 in the form of part of a hollow ellipsoid, for example a hollow partial sphere. A multiplicity of radar antennas 4 are attached on the inner side of the hollow ellipsoid and enable a high spatial resolution of the scene simulated for the distance radar instrument 2 to be tested, said scene being predetermined by the surroundings model 6 on the computer unit and being represented by the radar antennas. The opening of the ellipsoid is aligned to the distance radar instrument 2 to be tested and enables a representation of surrounding simulated obstacles with extent in the azimuthal and vertical direction (angle 9).

1-10. (canceled)

11. A test bench for testing a distance radar instrument by simulating distance and speed of obstacles, comprising
a radar emulation device comprising at least one radar antenna and a computer unit with a model of the surroundings, wherein the model of the surroundings comprises data of at least one obstacle with a relative position and speed from the distance radar instrument,
wherein the radar emulation device emits a suitable simulated reflection radar signal on the basis of the relative position and speed predetermined by the model of the surroundings at least partly in the direction of the distance radar instrument in response to a scanning radar signal from the distance radar instrument to enable the distance radar instrument to detect an obstacle with a predetermined relative position and speed,
wherein the radar emulation device extends over an angular range in front of the distance radar instrument such that the obstacle with relative position and speed can be simulated in this angular range with mutually distinguishable angles, and
wherein the radar emulation device comprises a multiplicity of stationary radar antennas which are distributed over the angular range.

12. The test bench of claim 11, wherein the number of radar antennas is selected in such a way that a predetermined angular resolution is obtainable.

13. The test bench of claim 11, wherein the multiplicity of radar antennas are arranged on a contour extending in a straight line.

14. The test bench of claim 11, wherein the multiplicity of radar antennas are arranged on a concave contour with an opening in the direction of the distance radar instrument.

15. The test bench of claim 11, wherein a first radar antenna receives the scanning signal and a second radar antenna subsequently transmits the reflection radar signal.

16. The test bench of claim 11, wherein the radar emulation device is designed in such a way that the scanning radar signal initially passes over at least one deflection mirror for mirroring radar waves prior to being detected by a radar antenna or wherein the reflection radar signal initially passes over at least one deflection mirror for mirroring radar waves prior to being detected by the distance radar instrument.

17. The test bench of claim 11, wherein the radar emulation device is connected to the distance radar instrument in a closed control loop in such a way that the obstacle can be simulated in real time.

18. A test bench for testing a distance radar instrument by simulating distance and speed of obstacles, comprising
a radar emulation device comprising at least one radar antenna and a computer unit with a model of the surroundings, wherein the model of the surroundings comprises data of at least one obstacle with a relative position and speed from the distance radar instrument,
wherein the radar emulation device emits a suitable simulated reflection radar signal on the basis of the relative position and speed predetermined by the model of the surroundings at least partly in the direction of the distance radar instrument in response to a scanning radar signal from the distance radar instrument to enable the distance radar instrument to detect an obstacle with a predetermined relative position and speed,
wherein the radar emulation device extends over an angular range in front of the distance radar instrument such that the obstacle with relative position and speed can be simulated in this angular range with mutually distinguishable angles, and
wherein the radar emulation device comprises a multiplicity of stationary radar antennas which are distributed over the angular range; and
wherein the azimuthal portion of the position of the simulated obstacle is represented by the azimuthal position of the detecting radar antenna of the radar emulation device and the vertical portion of the position of the simulated obstacle is represented by the vertical position of the detecting radar antenna of the radar emulation device.

19. The test bench of claim 18, wherein the azimuthal portion of the position of the simulated obstacle is represented by the azimuthal position of the radar antenna of the radar emulation device transmitting the reflection radar signal and the vertical portion of the position of the simulated obstacle is represented by the vertical position of the radar antenna of the radar emulation device emitting the reflection radar signal.

20. The test bench of claim 18, wherein the number of radar antennas is selected in such a way that a predetermined angular resolution is obtainable.

21. The test bench of claim 18, wherein the multiplicity of radar antennas are arranged on a contour extending in a straight line.

22. The test bench of claim 18, wherein the multiplicity of radar antennas are arranged on a concave contour with an opening in the direction of the distance radar instrument.

23. The test bench of claim 18, wherein a first radar antenna receives the scanning signal and a second radar antenna subsequently transmits the reflection radar signal.

24. The test bench of claim 18, wherein the radar emulation device is designed in such a way that the scanning radar signal initially passes over at least one deflection mirror for mirroring radar waves prior to being detected by a radar antenna or wherein the reflection radar signal initially passes over at least one deflection mirror for mirroring radar waves prior to being detected by the distance radar instrument.

25. The test bench of claim 18, wherein the radar emulation device is connected to the distance radar instrument in a closed control loop in such a way that the obstacle can be simulated in real time.

26. A test bench for testing a distance radar instrument by simulating distance and speed of obstacles, comprising
a radar emulation device comprising at least one radar antenna and a computer unit with a model of the surroundings, wherein the model of the surroundings comprises data of at least one obstacle with a relative position and speed from the distance radar instrument,
wherein the radar emulation device emits a suitable simulated reflection radar signal on the basis of the relative position and speed predetermined by the model of the surroundings at least partly in the direction of the distance radar instrument in response to a scanning radar signal from the distance radar instrument to enable the distance radar instrument to detect an obstacle with a predetermined relative position and speed,
wherein the radar emulation device extends over an angular range in front of the distance radar instrument such that the obstacle with relative position and speed can be simulated in this angular range with mutually distinguishable angles, and
wherein the radar emulation device comprises a multiplicity of stationary radar antennas which are distributed over the angular range; and
wherein the model of the surroundings comprises data about the material properties of the obstacle and the reflection radar signal emitted by the radar emulation device in the direction of the distance radar instrument is constituted in such a way that the radar emulation device emulates the material properties of the simulated obstacle, in particular by virtue of a predetermined characteristic damping of the reflection radar signal being associated with the material properties of the obstacle to be simulated.

27. The test bench of claim 26, wherein the radar emulation device is designed in such a way that the scanning radar signal initially passes over at least one deflection mirror for mirroring radar waves prior to being detected by a radar antenna or wherein the reflection radar signal initially passes over at least one deflection mirror for mirroring radar waves prior to being detected by the distance radar instrument.

28. The test bench of claim 26, wherein the radar emulation device is connected to the distance radar instrument in a closed control loop in such a way that the obstacle can be simulated in real time.
